(19) United States
(12) Patent Application Publication
(10) Pub. No.: US 2006/0056307 A1
(43) Pub. Date: Mar. 16, 2006

(54) Method and entity for monitoring traffic

(75) Inventors: Vesa Hellgren, Helsinki (FI); Julius Karlsson, Helsinki (FI); Arto Peltomaki, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/043,933

(22) Filed: Jan. 28, 2005

(30) Foreign Application Priority Data
Sep. 15, 2004 (GB) GB 0420549.8

(51) Int. Cl. H04L 12/26; H04Q 7/00

(52) U.S. Cl. 370/252; 370/328; 709/223

(57) ABSTRACT

This invention relates to a method of monitoring traffic comprising the steps of creating a traffic flow on receipt of data; determining if further data is received within a predetermined time; and terminating said traffic flow when no further data is received in said predetermined time.

### BACKGROUND OF THE INVENTION

1. Field of the Invention

The present invention relates to a method and entity for monitoring traffic.

2. Description of the Related Art

A communication system can be seen as a facility which enables communication between two or more entities such as user equipment, servers, gateways and/or other nodes. The communication may comprise, for example, communication of voice, data, multimedia and so on.

A GPRS (general packet radio service) is one example of a packet data standard. In particular, a GPRS based communication system provides wireless communication systems that provide packet switched data transmission for mobile user equipment. The GPRS operational environment comprises one or more service areas, which are interconnected by a GPRS backbone network. A service area may comprise a number of packet data service nodes. These services nodes are generally referred to as serving GPRS support nodes (SGSN). Each SGSN is connected to at least one radio access network. The access network may either be a 2G (a second generation) or 3G (third generation) access network.

The packet data serving nodes are connected to an external data network such as a packet switched packet data network PSPDN via gateways such as GPRS gateway support nodes (GGSN). An example of the data bearers that may be used to carry the traffic flows over GPRS is a packet data protocol (PDP) context. A PDP context typically includes a radio access bearer provided between the user equipment, the radio network controller and the SGSN, and switched packet data channels provided between the SGSN and the GGSN. A session between the user equipment and another party is carried on the PDP context.

When GPRS networks were first proposed, a restricted charging model was provided. The mobile subscribers were charged mainly based on the volume of traffic carried over one PDP context. If the operator wanted to have differentiated charging based on the services, for example browsing versus streaming traffic, the operator configured a separate access point for each traffic type. Thus, the mobile subscriber was forced to create a new PDP context for each service type. The first GPRS terminals did not support multiple PDP contexts, which significantly reduced the end user experience as the mobile subscriber was not able to use multiple services at the same time.

During recent years, improvements have been made in the GPRS networks with respect to the charging capabilities. The traffic analysis capabilities of for example the GGSN have been improved significantly. There is now no longer a need to define an access point for each service because the GGSN can classify traffic to multiple categories. Differentiated charging supports use of these categories. For example, browsing and streaming traffic can be carried over the same PDP context and access point. The GGSN just reports charging counters relating to browsing and streaming traffic in separate categories. Volume based charging is not the only option in differentiated charging. Two other charging types are also supported in the GGSN. Time based charging is used to meter how long the mobile subscriber used a particular service. For example, when a mobile subscriber browses a certain site, time based metering defines how long the mobile subscriber stayed on the site. Events or hits can also be charged for certain L7 protocols such as HTTP (hypertext transfer protocol). When ever the mobile subscriber fetches pages from the web server a new hit is counted.

In the widely used OSI model, the network protocols are divided into seven layers. The topmost layer, L7, protocol is dedicated to the application layer protocols. L7 protocols provide the services that end users actually use to interact with networks, for example FTP, telnet and HTTP.

Event based metering can currently only be used for L7 protocols and it requires that a corresponding L7 analysis be implemented in the GGSN. Implementing L7 analysis for all possible L7 protocols is not practical. In some cases, event based metering would be sufficient for charging. For mobile subscribers, the volume based and time based charging may not be easy to justify. The end user may not understand the metering process as it would require understanding the internal functionality of the metered traffic. Event based metering could simplify the business model.

One problem with known systems will now be described. Event based charging is not easy to define for email. Sending and receiving email may be considered as one event. However, the mobile subscriber may also execute other commands like moving email to another folder in the email server. It is then questionable as to how these commands should be charged.

In addition, there are many protocols which are used to implement the email service so it requires implementing a variety of L7 analysis software in the GGSN.

It is an aim of embodiments of the present invention to address or at least mitigate these problems.

### SUMMARY OF THE INVENTION

According to a first aspect of the present invention, there is provided a method of monitoring traffic comprising the steps of creating a traffic flow on receipt of data, determining if further data is received within a predetermined time and terminating said traffic flow when no further data is received in said predetermined time.

According to a second aspect of the present invention, there is provided an entity for monitoring traffic comprising means for creating a traffic flow on receipt of data; means for determining if further data is received within a predetermined time and means for terminating said traffic flow when no further data is received in said predetermined time.

According to a third aspect of the present invention, there is provided a system in which traffic is monitored comprising means for creating a traffic flow on receipt of data, means for determining if further data is received within a predetermined time and means for terminating said traffic flow when no further data is received in said predetermined time.

According to a fourth aspect of the present invention, there is provided a system in which traffic is monitored comprising user equipment and an entity between which a communication pathway is established, said entity being arranged to create a traffic flow on receipt of data, to check if further data is received in a predetermined time and to terminate said flow in the absence of further data associated with said data flow in said predetermined time.

According to a fifth aspect of the present invention, there is provided an entity for monitoring traffic comprising a traffic flow block adapted to create a traffic flow on receipt of data, a timer adapted to determine if further data is received within a predetermined time and to terminate said traffic flow when no further data is received in said predetermined time.

According to a sixth aspect of the present invention, there is provided a computer program product comprising a computer readable medium have thereon computer program code which when said program is loaded to make a computer execute procedure to create a traffic flow on receipt of data, determine if further data is received within a predetermined time, and terminate said traffic flow when no further data is received in said predetermined time.

### BRIEF DESCRIPTION OF THE DRAWINGS

For a better understanding of the present invention and as to how the same may be carried into effect, reference will now be made by way of example only to the accompanying drawings in which:

FIG. 1 shows schematically a communication system in which embodiments of the present invention may incorporate it;

FIG. 2 illustrates schematically traffic flow in an embodiment of the present invention;

FIG. 3 illustrates schematically layers 4 and 7 of the protocol stack used in embodiments of the present invention;

FIG. 4 shows a method embodying the present invention; and

FIG. 5 shows a GGSN embodying the present invention.

### DETAILED DESCRIPTION OF PREFERRED EMBODIMENTS

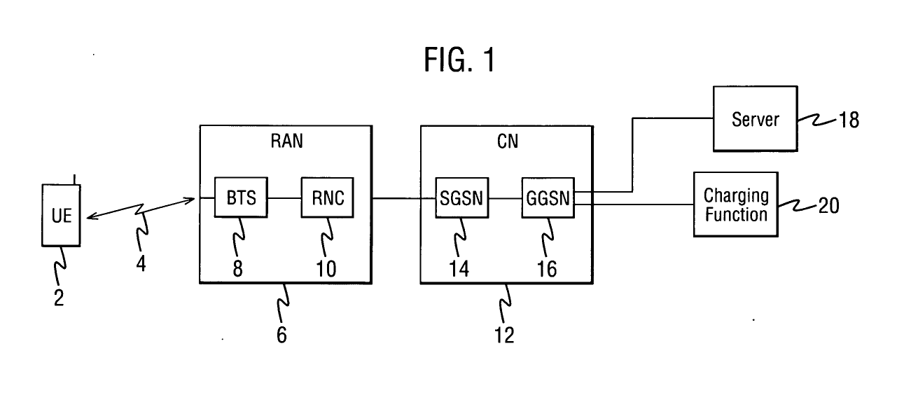

Certain embodiments of the present invention will now be described by way of example with reference to the architecture of a GPRS based mobile communications system shown in FIG. 1. However, it should be understood that embodiments of the present invention are applicable to any other suitable form of network as well.

As shown in FIG. 1, user equipment 2 is arranged communicate with a radio access network RAN 6 via a radio interface 4. The radio access network 6 will comprise a plurality of base transceiver stations BTS 8. For clarity, only one is shown in FIG. 1. The radio interface 4 will be between the user equipment 2 and a BTS 8. The radio access network 6 will be controlled by a radio network controller RNC 10. This in practice controls the base transceiver stations. More than one RNC may be provided in a RAN.

The radio access network 6 is connected to a core network 12. The core network comprises a SGSN 14 and a GGSN 16. In practice, more than one SGSN 14 may be provided in the core network. Likewise, more than one GGSN 16 may be provided. The GGSN 16 acts as a gateway and is connected to for example a server 18 providing a service. The GGSN 16 is also connected to a charging function 20. The charging function 20 is arranged to receive information from the GGSN 16 which allows the operator to determine a charge associated with the provision of a service from for example the server 18.

The user equipment is arranged to communicate with the radio network controller by radio network channels which are typically referred to as radio bearers RB. These radio network channels are set up in a known manner. Each user equipment 2 may have one or more radio network channels opened at any one time with radio network controller.

The relevant radio access network controller is in communication with the SGSN 14 via an appropriate interface, for example the Iu interface.

The SGSN 14 communicates with the GGSN 16 via the GPRS backbone network. This interface is commonly a switched packet data interface.

The user equipment can take any known form for example a mobile station, mobile telephone, personal computer, personal data assistant (PDA) or any other suitable device.

The user equipment is normally configured for wireless communication and may thus include an antenna element for wirelessly transmitting and receiving signals to and from the base station. Typically, the user equipment will have a display for displaying images and/or other graphically information for the user. Speaker means typically are also provided. The user interface such as control buttons, keypad, voice commands etc, are provided for controlling the user equipment. A user can use the user equipment for tasks such as for example making and receiving phone calls, for receiving and sending data from and to the network and for experiencing for example multimedia content by means of a PDP context.

In embodiments of the present invention, overall communication between the user equipment 2 and the GGSN 16 is via a PDP context. Each PDP context provides a communication pathway between a particular user equipment and the GGSN. Once established, a PDP context can carry one or more flows. Each flow typically represents, for example, a particular service and/or a media component of a particular service. The PDP context therefore represents a logical communication pathway for one or more flows across the network. To implement the PDP context between the user equipment and the SGSN 14, radio access bearers RAB are established which commonly allow for data transfer for the user equipment. The implementation of these logical and physical channels is well known to those skilled in the art and therefore is not discussed further.

It should be appreciated that other access networks, for example non cellular access network, may also be used for establishing a client access bearer between the user equipment and the GGSN. Such an access bearer should be understood to be equivalent to a PDP context and should also provide a logical communication pathway across the network. For example, in WLAN (wireless local area network) or fixed broadband access networks, a client access bearer may be realised by means of a virtual private network (VPN) point to point protocol PPP or mobile IP (Internet Protocol) technology.

Embodiments of the invention are applicable in both cellular communications networks as well as non cellular networks such as WLAN. Embodiments of the invention can be used with any access network type.

The user equipment is able to connect via the GPRS network to servers, for example server 16 which is connected to an external data network.

Reference is made to FIG. 3 which shows the protocol stack used in for example GPRS systems. Layers L3 to L7 are illustrated. Layer L7 supports various different protocols of which HTTP is one example. L3 supports IP Internet protocol whilst L4 is the TCP layer.

Embodiments of the present invention record one event or hit whenever traffic belonging to a certain IP flow is detected. After that a timer is started. When the timer expires, the event is considered to have been completed and whenever there is some new traffic in the related IP flow, a new event or hit is recorded.

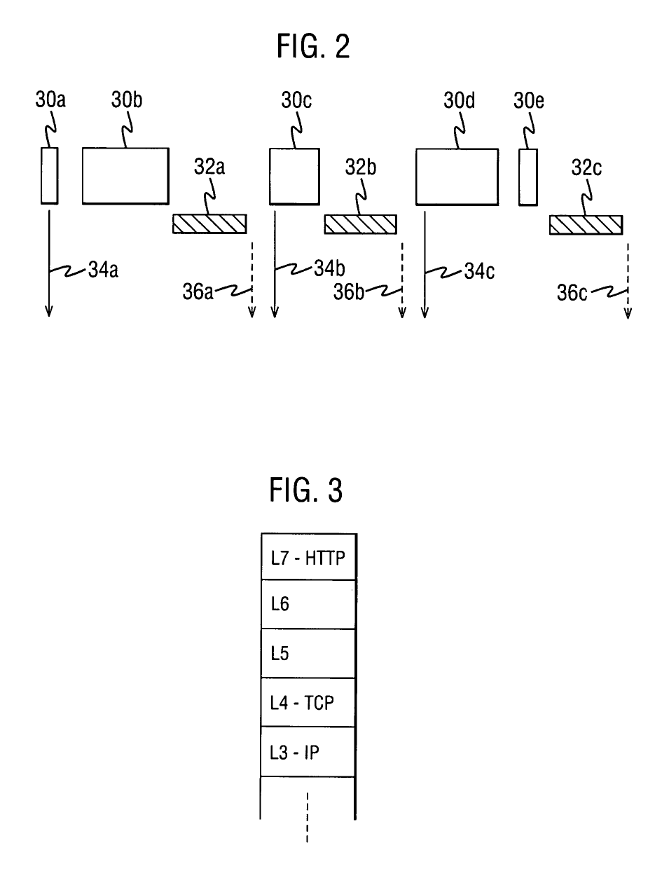

Reference is now made to FIG. 2. The boxes referenced 30a-e represent traffic which matches a certain IP flow definition. The arrows 34a to c represent the time when a new event or hit is recorded. Arrows 36a to c represent when the timer (represented by blocks 32a to c) have expired and there is no activity related to the IP flow.

The flow shown in FIG. 2 will now be described in more detail. Initially, a short burst of traffic (represented by block 30a) relating to an IP flow is detected. A hit is recorded as indicated by arrow 34a. The timer is started.

Before the timer expires, new traffic represented by block 30b is detected in the IP flow. The timer is restarted when the traffic ends. No new event is recorded. As can be seen by block 32a, the timer expires as represented by arrow 36a before the next traffic is received.

After the timer has expired, new traffic 30c belong to the IP flow is detected. As the timer has expired, a new event or hit is recorded. This is represented by arrow 34b.

Again, the timer is started as represented by block 32b. The timer expires as represented by arrow 36b before the next traffic is received.

A further block of traffic represented by block 30d is received at a time represented by arrow 34c. As this is after the expiry of the timer, a new event is detected.

The timer is started but before the timer expires, a further burst of traffic represented by block 30e is received. Accordingly, the traffic represented by block 30e will not be considered to be a new event or hit. After the receipt of the block of traffic represented by block 30e, the timer is restarted and as represented by block 32c it expires at a time represented by arrow 36c.

Thus, in the illustrated traffic flow of FIG. 2, three events are recorded.

The expiry time for the timer can be defined specifically for each IP flow. In some embodiments of this invention, this may be important in that it is possible to take into account the varying temporal characteristics of each traffic type. The value selected for the time may additionally or alternatively depend on how the operator wants to define the event for a particular traffic type. For example, in browsing, a relatively long expiry time can be set as it can be assumed that the end user spends some time before the next web transaction is started. Alternatively, if the expiry time is relatively short for example for browsing, the end result may be similar to the case where L7 hits are metered explicitly (i.e. each web transaction is metered as a separate event). Thus, by using different expiry time values, different business models for, for example browsing traffic, can be supported in the GGSN.

The implementation of embodiments of the present invention will now be described in more detail. It should be appreciated that in embodiments of the present invention, the implementation is on the IP layer i.e. L3 and not layer 7 L7 as in the prior art.

Each IP flow is defined as a tuple which consists of the following:
Uplink IP address/subnet;
Uplink port number or range of ports; and
IP protocol identifier which identifies the protocol used which may for example be TCP (transmission controller protocol.

Optionally, the downlink port number may also be included in the IP flow definition. These level 3 IP flows are used to classify the traffic to different categories. These IP flows are on the established PDP context. It should be appreciated that a given PDP context may support one or more different IP flows.

Whenever traffic in the PDP context matches with a new IP flow, a dynamic IP flow is created and an event is recorded. The static IP flow may be defined with sub nets but the dynamic IP flow is always using the exact IP address and port numbers. Thus, there may be several different dynamic IP flows relating to a single static IP flow. In other words, a static IP flow will be between entity A and entity B. A dynamic flow will be between entity A and a specific port of entity B.

FIG. 5 schematically shows the function of the GGSN. It should be appreciated that these actual entities will probably all form part of the processor and associated memory of the GGSN. The GGSN has a traffic flow identification block 44 which is arranged to identify the dynamic IP flow to which traffic received belongs and to establish new flows. A timer 40 is provided. This will determine whether or not the timer has expired for a particular traffic flow. An event counter 42 is provided which updates the counter every time an event or hit is recorded.

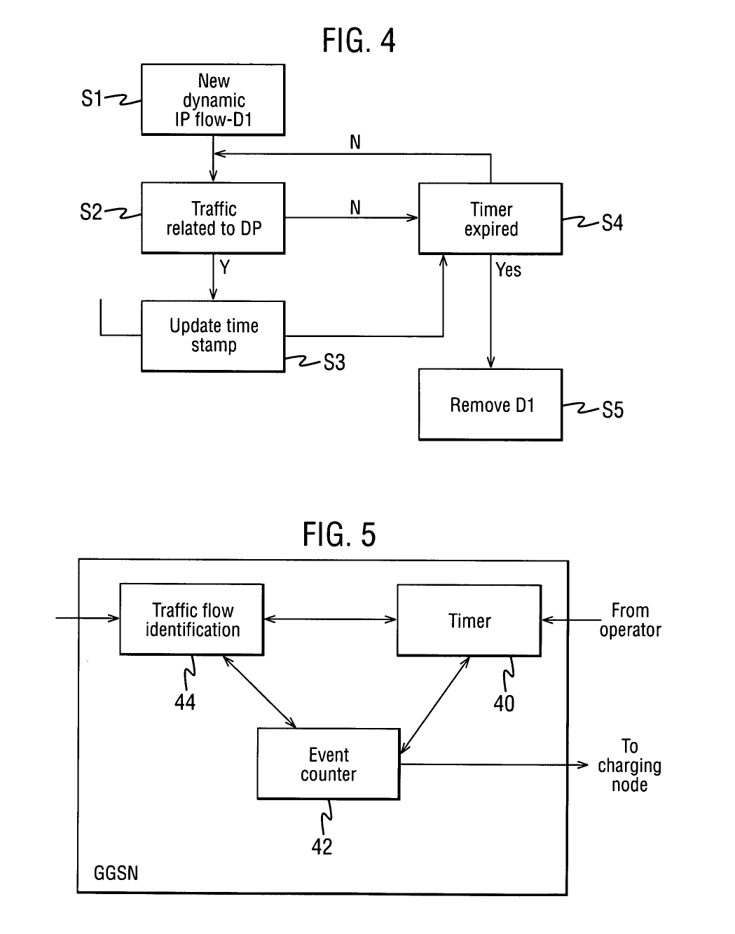

Reference will now be made to FIG. 4 which shows a flow chart of a method embodying the present invention.

One of the attributes of the dynamic IP flow is the time stamp of the last received IP packet. This defines the time used by the timer. Thus, if X is the expiry time for the timer, T is the current time and L is the time stamp of the last IP packet, then the timer has expired if T−L is greater than X. The timer 40 of the GGSN will periodically check the time stamp of the last received IP packet for each dynamic IP flow. If a corresponding timer has expired, the dynamic flow is removed. If there is traffic which matches with an existing dynamic IP flow, the time stamp on the last IP packet to be received is up dated and no new event is recorded.

This will be described in more detail with reference to FIG. 4.

There is one L3 IP flow in the configuration. It matches with all traffic which is going to a sub net address 128.168*.*.

A packet to IP address 128.168.120.3 is received and it matches the IP flow configuration. A new dynamic IP flow D1 is created and an event is recorded. This is represented by step S1 of FIG. 4. The new dynamic IP flow D1 is identified in block 44 of the GGSN which will cause the event counter to be incremented. The time stamp contained in the packet received is sent to the timer 40. The timer 40 is started.

In step S2, the traffic flow identifier block 44 of the GGSN checks to see whether or not there is any further traffic flow related to traffic flow D1. If there is, then the next step is step S3.

In step S3, the new time stamp of the next packet to be received in IP flow D1 is sent to the timer. This effectively resets the timer and it starts the period again. In some embodiments of the present invention, additional metering may also be done for the traffic for example volume based metering.

Step S3 is followed by step S4 which is described in more detail later.

Another packet, this time with the IP address 128.168.120.54 is received. It does not match with the dynamic IP flow D1 but it matches with the L3 IP flow configuration. Thus, a new dynamic IP flow D2 is created and another hit is recorded. It should be appreciated that this dynamic flow D2 will be treated in exactly the same way as described in relation to FIGS. 4 and 5. Thus, there may be traffic related to both IP flows D1 and D2.

Reverting back to FIG. 4, if it is determined in step S2 that there is no traffic related to flow D1, then a check is made in step S4 to see whether or not the timer has expired. In practice, instead of checking to see whether the timer has expired periodically, the timer may generate a message indicating when that time has expired.

If the timer has not expired, then the next step would be step S2. Again, this loop back to step 2 will depend on the implementation i.e. whether or not the timer is periodically checked or whether the timer will automatically generate an expired message.

When it is determined that the timer has expired, then the next step will be S5 which will removed the D1 flow, that is peform garbage collection. Garbage collection is the process which monitors usage of the dynamically allocated data structures or memory. If the garbage collection determines that the data structure is no longer needed, the data structure is deallocated and the memory it reserves can be reallocated. In embodiments of the invention, garbage collection monitors usage of the dynamically allocated IP flows and deallocates them when there is not longer traffic related to the IP flow—ie the timer has expired.

Consider the following example. There is traffic relating to both D1 and D2. Eventually, the traffic related to D2 ends. The IP flow D2 will be removed. Whilst there is still traffic in the IP flow D1, it is not removed.

The traffic to IP address 128.168.120.54 is started again after a while as the D2 IP flow was removed, a new dynamic IP flow D3 is created and an event is recorded. The other dynamic flow D1 is still active because there is traffic.

Eventually, both D1 and D3 will be removed because of a lack of traffic and the expiry of the timer. In this scenario described, three events are recorded.

The expiry times for the timer can be configured locally or may be received from an external network, for example the charging rules function CRF. The events counted by the event counter will be sent to the charging node. The timer can work start on receipt on the beginning, end or middle of a packet. The preferred embodiments of the present invention use the time stamp information contained in a packet. However in alternative embodiments of the present invention, the timer may be triggered by the receipt of the packet itself.

Embodiments of the present invention have the advantage that event based charging is supported without the need for extensive L7 analysis. This makes embodiments of the present invention much simpler to implement. As the events are defined in the L3 level, the metering does not depend on the L7 service and thus an understanding of the various L7 protocols is not required. Some of the advantages of the L7 service can be emulated by controlling the expiry time used by the timer either by external control in the GGSN or from an external source.

It should be appreciated that embodiments of the present invention can be applied in any other communication system other than a GPRS system. Embodiments of the present invention can be applied in a wired or a wireless environment. Embodiments of the invention are particularly applicable in a circuit switched environment.

1. A method of monitoring communication traffic comprising the steps of:
creating a traffic flow on receipt of data;
determining if further data is received within a predetermined time; and
terminating said traffic flow when no further data is received in said predetermined time.

2. A method as claimed in claim 1, further comprising the step of recording an event when said traffic flow is created.

3. A method as claimed in claim 2, further comprising the step of sending information indicating at least one event to a charging node.

4. A method as claimed in claim 1, further comprising the step of selecting said predetermined time.

5. A method as claimed in claim 4, wherein said predetermined time is selected based on a type of said traffic or a type of service associated with said traffic.

6. A method as claimed in claim 1, wherein said determining step comprises using time stamp information contained in said data.

7. A method as claimed in claim 6, wherein said determining step further comprises subtracting the time stamp information from current time information.

8. A method as claimed in claim 1, wherein said traffic flow is an IP traffic flow.

9. A method as claimed in claim 1, wherein said traffic flow is a dynamic traffic flow.

10. A method as claimed in claim 1, wherein said data comprises packet data.

11. A method as claimed in claim 1, wherein said determining step comprises determining if said further data is associated with the created traffic flow.

12. An entity for monitoring communication traffic comprising:
means for creating a traffic flow on receipt of data; means for determining if further data is received within a predetermined time; and means for terminating said traffic flow when no further data is received in said predetermined time.

13. An entity as claimed in claim 12, further comprising means for recording an event when a traffic flow is created.

14. An entity as claimed in claim 13, further comprising means for sending information indicating events to a charging node.

15. An entity as claimed in claim 12, wherein said determining means is configured to select different predetermined times.

16. An entity as claimed in claim 15, wherein said predetermined time is selected by said determining means according to one of the type of said traffic, a type of service associated with said traffic, or in response to an external signal.

17. An entity as claimed in claim 12, wherein said determining means is configured to check time stamp information contained in said data to determine if said data is received within the predetermined time.

18. An entity as claimed in claim 17, wherein said determining means is configured to subtract the time stamp information from current time information.

19. An entity as claimed in claim 12, wherein said determining means is configured to determine if said further data is associated with the created traffic flow.

20. An entity as claimed in claim 12, wherein said entity further comprises a GPRS gateway support node.

21. A system in which communication traffic is monitored comprising:
means for creating a traffic flow on receipt of data;
means for determining if further data is received within a predetermined time; and
means for terminating said traffic flow when no further data is received in said predetermined time.

22. A system in which communication traffic is monitored comprising:
user equipment and an entity between which a communication pathway is established, said entity being configured to create a traffic flow on receipt of data, determine if further data is received in a predetermined time and to terminate said traffic flow if no further data related to said data flow is received in said predetermined time.

23. An entity for monitoring communication traffic comprising:
a traffic flow block configured to create a traffic flow on receipt of data; and
a timer configured to determine if further data is received within a predetermined time and to terminate said traffic flow when no further data is received in said predetermined time.

24. A computer program product comprising a computer readable medium having thereon computer program code which when said program is loaded to make a computer execute a procedure to create a traffic flow on receipt of data, determine if further data is received within a predetermined time, and terminate said traffic flow when no further data is received in said predetermined time.
